(19) United States
(12) Patent Application Publication
(10) Pub. No.: US 2025/0070511 A1
(43) Pub. Date: Feb. 27, 2025

(54) ATTACHMENT DEVICE FOR ATTACHMENT TO CABLE

(71) Applicant: Sony Interactive Entertainment Inc., Tokyo (JP)

(72) Inventors: Masaho MORITA, Tokyo (JP); Yoshihiro AOYANAGI, Kanagawa (JP); Kenta KIDOBA, Kanagawa (JP); Kazuyuki SUZUKI, Kanagawa (JP); Takeshi IGARASHI, Kanagawa (JP); Hitoshi FUNATSU, Tokyo (JP)

(73) Assignee: Sony Interactive Entertainment Inc., Tokyo (JP)

(21) Appl. No.: 18/723,509

(22) PCT Filed: Sep. 30, 2022
(86) PCT No.: PCT/JP2022/036839

§ 371 Date: Jun. 24, 2024

(30) Foreign Application Priority Data
Dec. 24, 2021 (JP) 2021-211391

(51) Int. Cl. H01R 13/639; H01R 13/50; H01R 13/627; H01R 13/635

(52) U.S. Cl. CPC H01R 13/639; H01R 13/501; H01R 13/6273; H01R 13/635; H01R 2201/06

(57) ABSTRACT

Provided is an attachment device that is able to improve the stability of connection between a cable connector and a connector of an input device and also facilitate the operation for engaging an engagement section with the input device. The attachment device includes a connector retaining section and an engagement member. The engagement member is provided on the connector retaining section, and includes an engagement section for engaging with the input device. The engagement member is movable between an engagement position and an accommodation position. The engagement position is a position where the engagement section is protruded from the connector retaining section. The accommodation position is a position where the engagement section is accommodated in the connector retaining section.

### TECHNICAL FIELD

The present disclosure relates to an attachment device that is used to connect a cable to an input device.

### BACKGROUND ART

An input device to be used in game play is disclosed in PTL 1, which is indicated below. Many recent input devices are wirelessly connected to game devices, and signals corresponding to operations performed on the input devices are wirelessly transmitted to the game devices.

### CITATION LIST

### Patent Literature

### PTL 1

U.S. Patent Application Publication No. 2021/0299554

### SUMMARY

### Technical Problem

In order to ensure a stable connection between a game device and an input device, there is a demand for connecting them by wire. Particularly in a game event and in a game competition, the stability of connection between the game device and the input device is important. Therefore, participants and managers of such events and the like strongly demand that the game device and the input device be connected by wire.

### Solution to Problem

The present disclosure proposes an attachment device that can be attached to a cable connector that is provided at an end of a cable to establish a connection between the cable and an input device. An example of the attachment device includes a connector retaining section and an engagement member. The connector retaining section is attachable to and detachable from the cable connector. The engagement member is provided on the connector retaining section. The engagement member includes at least one first engagement section for engaging with the input device. The engagement member is movable between a protrusion position and an accommodation position. The protrusion position is a position where the at least one first engagement section is protruded from the connector retaining section. The accommodation position is a position where the at least one first engagement section is accommodated in the connector retaining section.

The attachment device described above is able to improve the stability of connection between the cable connector and a connector of the input device. Further, the above-described attachment device is able to facilitate the operation for engaging the input device with the engagement section of the attachment device.

### BRIEF DESCRIPTION OF DRAWINGS

FIG. 1 is a perspective view illustrating a first example of an attachment device proposed by the present disclosure, the attachment device being illustrated with a cable attached thereto.

FIG. 2 is a perspective view illustrating the rear side of the attachment device depicted in FIG. 1.

FIG. 3A is a perspective view of the attachment device depicted in FIG. 1. In FIG. 3A, a cable connector retaining section is uncovered to reveal a cable connector provided at the end of the cable.

FIG. 3B is a perspective view of the attachment device depicted in FIG. 1. In FIG. 3B, the cable connector retaining section is uncovered, and the cable is detached from the attachment device.

FIG. 4 is an exploded perspective view illustrating an outer case, an inner case, an engagement member, and an operation member that are included in the attachment device depicted in FIG. 1.

FIG. 5A is a cross-sectional view of the attachment device taken along line V-V of FIG. 1.

FIG. 5B is a cross-sectional view of the attachment device taken along the same line as in FIG. 5A. The engagement member of the attachment device is engaged with an engagement section included in an input device.

FIG. 5C is a cross-sectional view of the attachment device taken along the same line as in FIG. 5A. The engagement member of the attachment device is disengaged from the engagement section included in the input device.

FIG. 6A is a plan view illustrating an example of the input device that is to be connected to the cable.

FIG. 6B is a rear view of the input device depicted in FIG. 6A.

FIG. 7 is a perspective view illustrating a second example of the attachment device proposed by the present disclosure.

FIG. 8 is a perspective view illustrating a state where the attachment device depicted in FIG. 7 is uncovered.

FIG. 9A is an exploded perspective view of the attachment device depicted in FIG. 7.

FIG. 9B is an enlarged view of the engagement member, the operation member, and a fixed support member that are depicted in FIG. 9A.

FIG. 10A is a cross-sectional view of the attachment device taken along line X-X of FIG. 7. In FIG. 10A, the operation member is disposed in an accommodation operation position.

FIG. 10B is a cross-sectional view taken along line Xb-Xb of FIG. 10A.

FIG. 11 is a cross-sectional view of the attachment device taken along the same line as in FIG. 10A. In FIG. 11, the operation member is disposed in a disengagement operation position.

FIG. 12A is a cross-sectional view of the attachment device taken along the same line as in FIG. 10A. In FIG. 12A, the operation member is disposed in an engagement operation position.

FIG. 12B is a cross-sectional view taken along line XIIb-XIIb of FIG. 12A.

FIG. 13 is a cross-sectional view of the attachment device. In FIG. 13, the engagement member is placed in an accommodation position and in a disengaged posture.

### DESCRIPTION OF EMBODIMENT

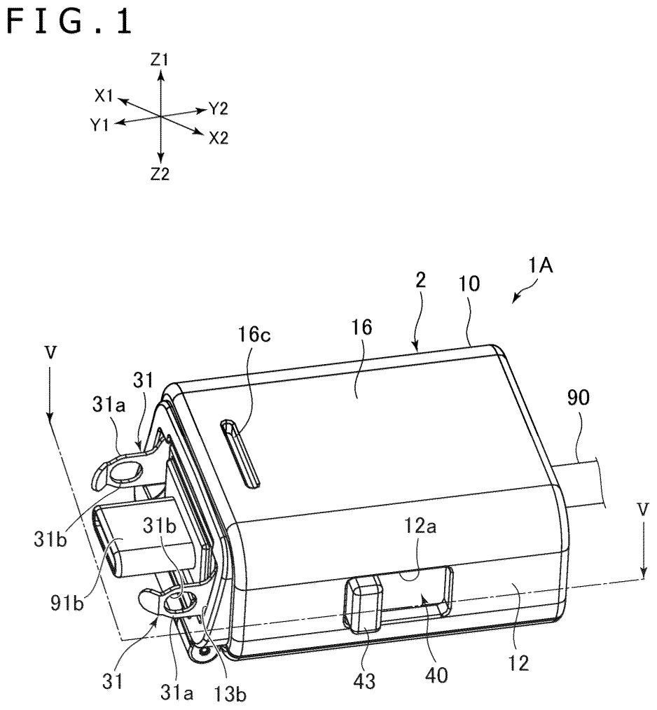

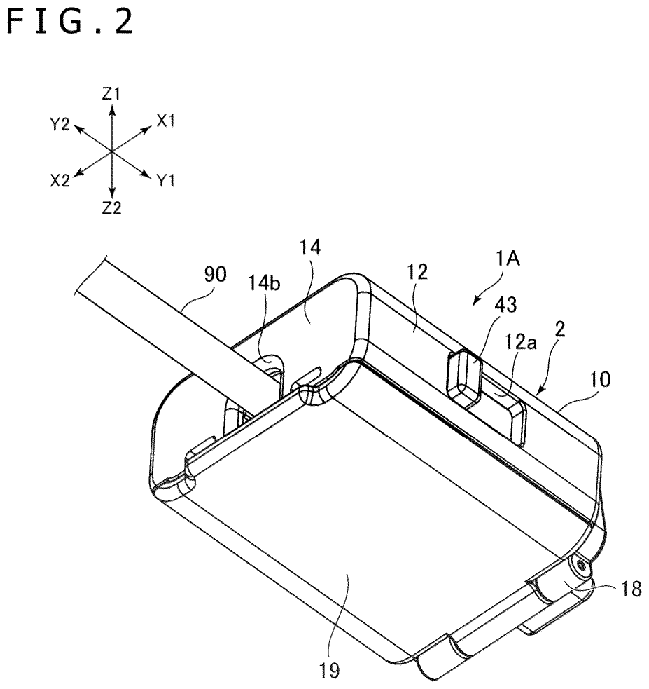

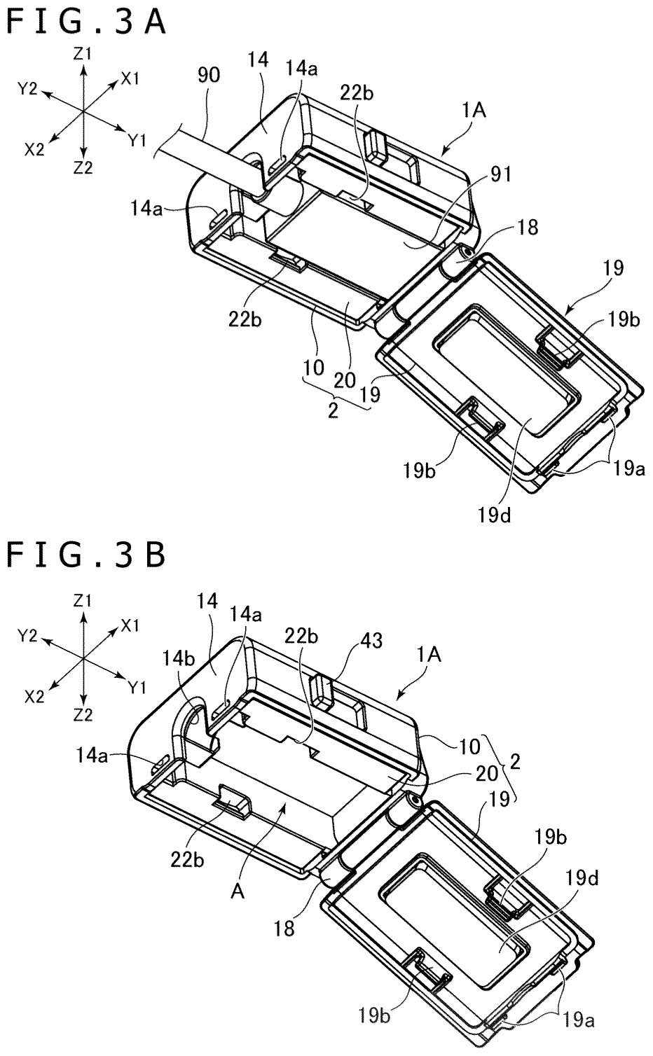

An attachment device proposed by the present disclosure will now be described. In this document, an attachment device 1A depicted, for example, in FIG. 1 is described as a first example of the attachment device proposed by the present disclosure. The attachment device 1A is to be attached to a cable connector 91 (see FIG. 3A) that is to be disposed on an end of a cable 90. The cable 90 is to be connected to an input device 80 for use, for example, in game play, through the cable connector 91.

In the following description, directions indicated by X1 and X2 in FIG. 1 are referred to as a rightward direction and a leftward direction, respectively, and directions indicated by Z1 and Z2 are referred to as an upward direction and a downward direction, respectively. These directions are used to explain the relative positional relation between the elements (parts, members, and sections) of the attachment device 1A, and are not used to identify the posture of the attachment device 1A during its use.

### [Input Device]

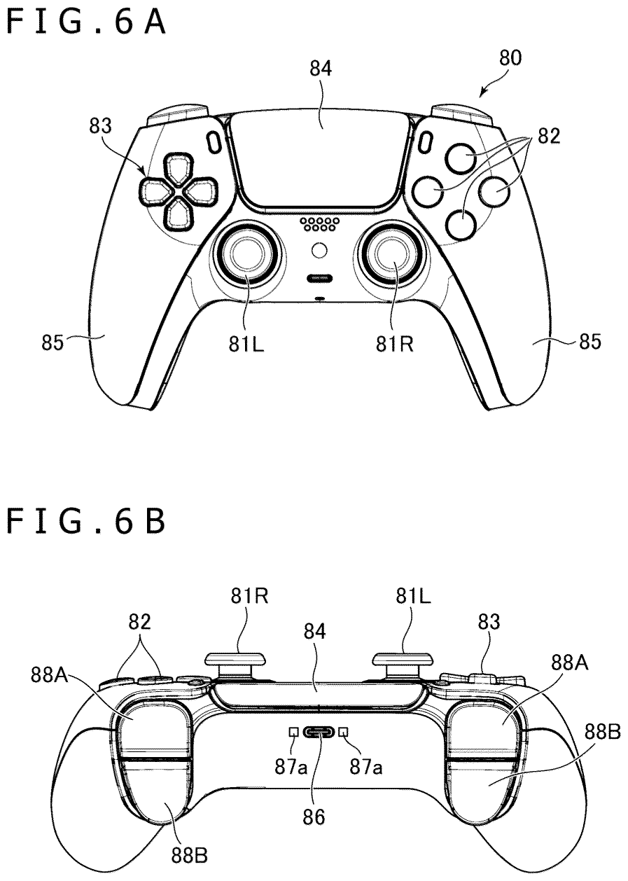

First, an example of the input device will be described. The input device 80 illustrated in FIGS. 6A and 6B is a device that is to be used in game play. As depicted in FIG. 6A, for example, left and right operation sticks 81L and 81R, a plurality of operation buttons 82, and direction keys 83 are mounted on the upper surface of the input device 80. The input device 80 may include a touchpad 84 that has a touch sensor and is able to detect a pressing operation performed by a user. An operation button 88A and a trigger button 88B may be disposed on both the left and right sections of the front side of the input device 80. Further, a grip 85 extended rearward may be provided on both the left and right sections of the input device 80.

The input device 80 is to be connected through the cable 90 to a game device (not depicted) that executes a game program. The input device 80 transmits signals corresponding to operations performed, for example, on the operation sticks 81L and 81R, to the game device through the cable 90, and receives control signals regarding vibration and LED (Light Emitting Diode) light emission from the game device. A communication module for wirelessly communicating with the game device may be built in the input device 80. Further, the input device 80 may receive power through cable 90.

As depicted in FIG. 6B, the input device 80 has a connector 86 (referred to as a device connector) that is mounted, for example, on its front side. The device connector 86 is an interface connector that is compliant, for example, with the USB (Universal Serial Bus) standard. However, the device connector 86 need not necessarily be compliant with the USB standard.

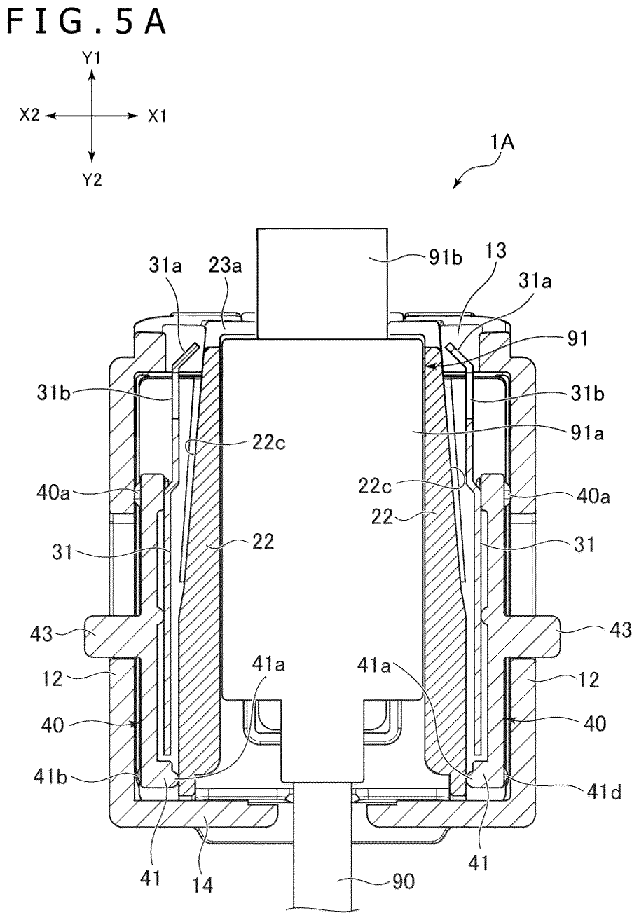

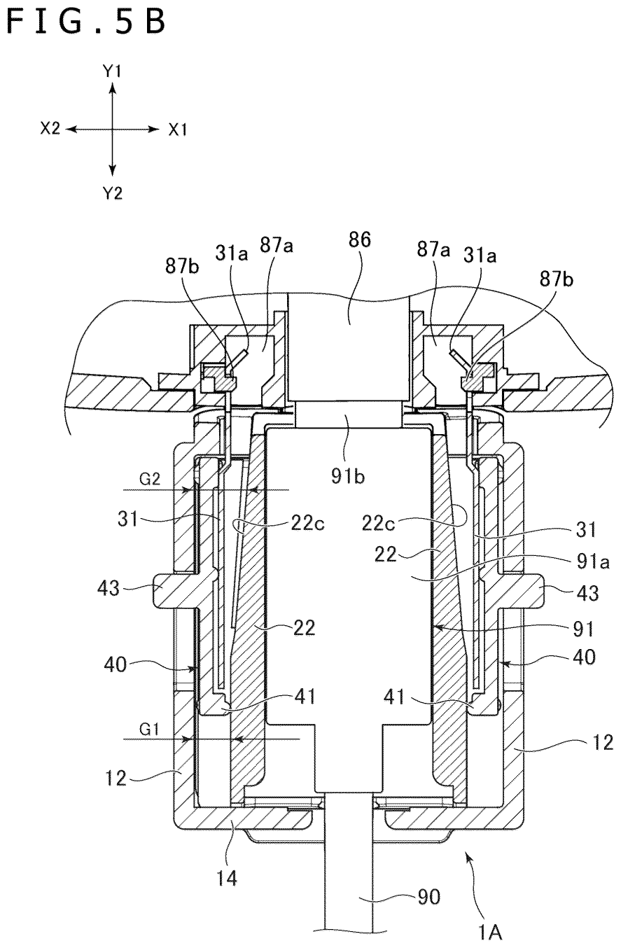

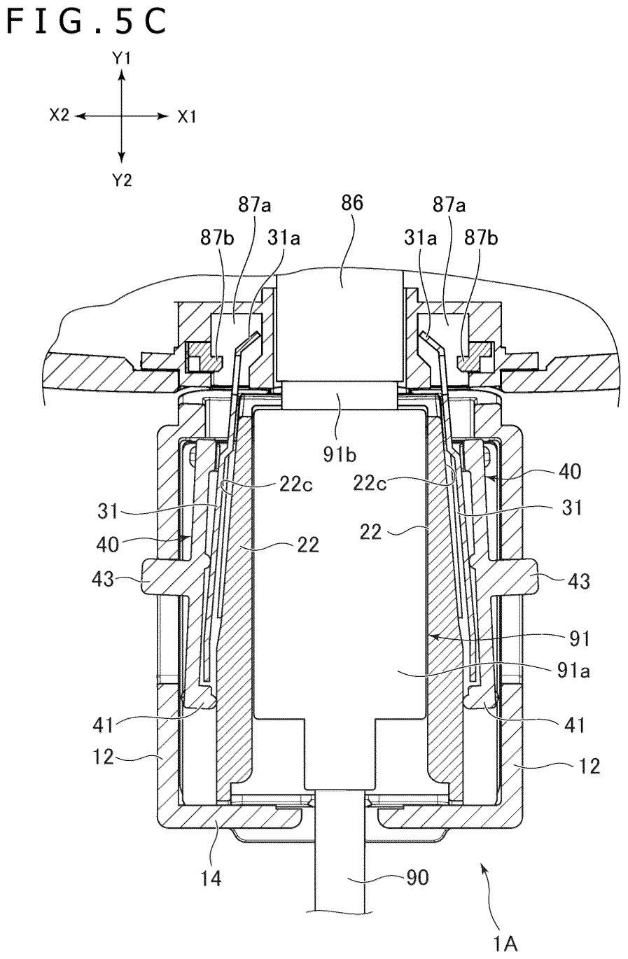

The input device 80 has fitting recesses 87a into which engagement sections 31 (see FIG. 1) of the attachment device 1A, which will be described later, fit. The fitting recesses 87a may be respectively formed in the left and right sides of the device connector 86. An engagement section 87b (see FIG. 5B) is formed inside each of the fitting recesses 87a.

### [Cable]

As depicted in FIG. 3A, the cable 90 has the connector 91 at its end. The connector 91 is hereinafter referred to as the cable connector. As depicted in FIG. 5A, the cable connector 91 has an insulating section 91a and a terminal section 91b. The insulating section 91a is formed by resin. The terminal section 91b is protruded forward from the insulating section 91a. The terminal section 91b includes, for example, a ground terminal and a plurality of signal terminals. The ground terminal has a cylindrical shape. The signal terminals are disposed inside the ground terminal.

### [Attachment Device]

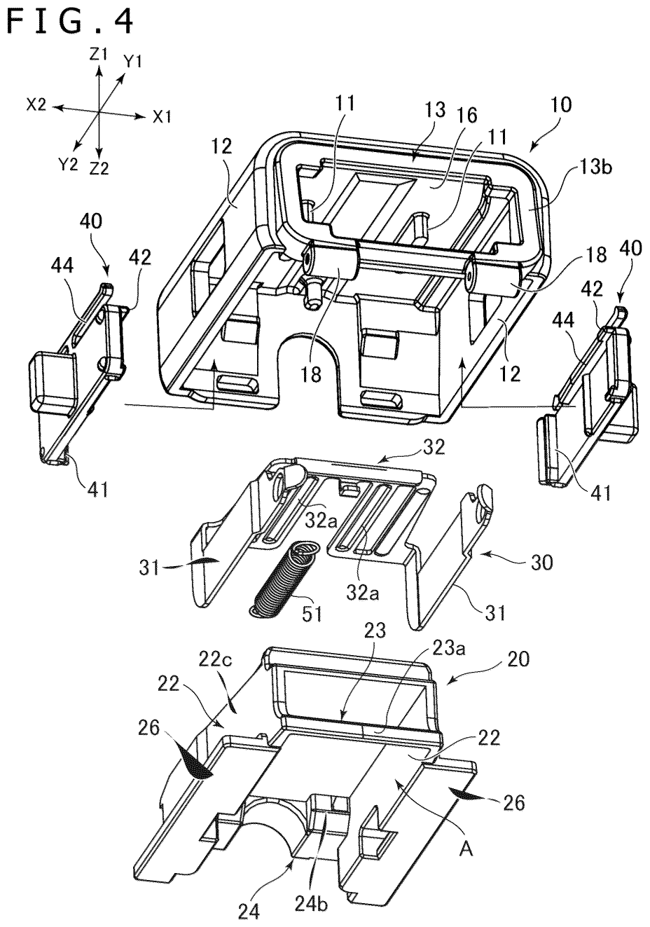

The attachment device 1A includes an engagement member 30 (see FIG. 4), a cable connector retaining section 2 (see FIG. 3A), and an operation member 40 (see FIG. 4). The engagement member 30 is provided for engaging with the input device 80. The cable connector retaining section 2 is provided for retaining the cable connector 91. The operation member 40 is provided to allow the user to operate the engagement member 30.

### [Cable Connector Retaining Section]

As depicted in FIG. 4, the cable connector retaining section 2 may include an outer case 10 and an inner case 20. The inner case 20 is disposed inside the outer case 10. The outer case 10 may be, for example, in the shape of a box that is open downward. The inner case 20 may have a connector accommodation chamber A that is open downward. As depicted in FIGS. 3A and 3B, the cable connector 91 can be disposed in the connector accommodation chamber A. The cable connector retaining section 2 is attachable to the cable connector 91 (i.e., the cable connector 91 can be disposed in the connector accommodation chamber A), and is detachable from the cable connector 91. The cable connector retaining section 2 has surfaces (front wall sections 13 and 23) facing the input device 80 and an opening that exposes the terminal section 91b of the cable connector 91.

As depicted in FIG. 3A, the cable connector retaining section 2 may include a cover 19 that closes the lower sides of the cases 10 and 20. The cover 19 may be coupled to the outer case 10 through a hinge section 18 provided on the outer case 10 and be openable and closable around the hinge section 18. The hinge section 18 may be provided, for example, at the lower edge of the front wall section 13 of the outer case 10.

The cable connector retaining section 2 need not necessarily be box-shaped. In a case where the cable connector retaining section 2 is not box-shaped, the cable connector retaining section 2 does not need to have the cover 19 that can be opened and closed.

### [Engagement Member]

As depicted in FIG. 1, the engagement member 30 has engagement sections 31 for engaging with the input device 80. The engagement member 30 has two engagement sections 31. The two engagement sections 31 are separated from each other in a direction (a left-right direction in this document) perpendicular to a fitting direction of the connectors 91 and 86 (a front-rear direction in this document). As depicted in FIG. 5A, the two engagement sections 31 are positioned on opposite sides of the cable connector 91. That is, the two engagement sections 31 are positioned on opposite sides of the connector accommodation chamber A. The two engagement sections 31 engage with the engagement sections 87b (see FIG. 5B) that are provided on the left and right sides of the device connector 86, respectively. As will be explained in detail later, the two engagement sections 31 are like leaf springs and can be elastically deformed toward the center in the left-right direction.

The engagement member 30 is movable in the front-rear direction between a protrusion position and an accommodation position. The protrusion position is a position where the engagement sections 31 are protruded from the cable connector retaining section 2. The accommodation position is a position where the engagement sections 31 are accommodated in the connector retaining section 2. As depicted in FIG. 5A, when the engagement member 30 is in the accommodation position, the engagement sections 31 are entirely accommodated in the cable connector retaining section 2. That is, tips 31a of the engagement sections 31 are positioned rearward from the front end of the cable connector retaining section 2. The protrusion position is the position of the engagement member 30 depicted in FIGS. 1 and 5B. When the engagement member 30 is in the protrusion position, the tips 31a of the engagement sections 31 are protruded forward from the cable connector retaining section 2.

The above-described structure of the attachment device 1A makes it possible to improve the stability of connection between the input device 80 and the cable 90. Further, by completing the connection between the cable connector 91 and the device connector 86 and then moving the engagement member 30 from the accommodation position to the protrusion position, the engagement sections 31 can be engaged with the engagement sections 87b of the input device 80. Therefore, it is unnecessary to simultaneously perform the alignment of the cable connector 91 with the device connector 86 and the alignment of the tips 31a of the engagement sections 31 with the fitting recesses 87a formed in the input device 80. This results in facilitating the operation for engaging the engagement sections 31 with the engagement sections 87b of the input device 80. Further, by disposing the engagement member 30 in the accommodation position when the attachment device 1A is not used, it is possible to avoid the action of external force not intended by the engagement sections 31.

As depicted in FIG. 1, the tips 31a of the engagement sections 31 may be bent toward the center in the left-right direction. Such a bend further facilitates the operation for engaging the engagement sections 87b of the input device 80 with the engagement sections 31 of the attachment device 1A. More specifically, when the user moves the engagement member 30 from the accommodation position to the protrusion position, the engagement sections 31 come into contact with the engagement sections 87b in the process of such movement, and elastically deform toward the center in the left-right direction according to the shapes of the tips 31a. Subsequently, when the tips 31a of the engagement sections 31 fully fit into the fitting recesses 87a, the engagement sections 87b fit into holes 31b formed in the tips 31a. This completes the engagement between the engagement sections 87b and the engagement sections 31, and causes the attachment device 1A to restrict the movement of the cable connector 91 in a direction in which the cable connector 91 is disconnected from the device connector 86.

It should be noted that the structures of the engagement sections 31 and 87b are not limited to those described here. For example, protrusions protruding outward in the left-right direction may be formed on the engagement sections 31. Further, recesses into which the protrusions fit may be formed in the inner surfaces of the fitting recesses 87a.

As depicted in FIG. 4, the engagement member 30 has a coupling plate 32 that is to be connected to the bases of the two engagement sections 31. This structure reduces the number of parts and facilitates the assembly of the attachment device 1A.

The coupling plate 32 may be connected, for example, to the upper edges of the bases of the engagement sections 31. The coupling plate 32 is guided by a guide 11 formed on the cable connector retaining section 2 (specifically, the outer case 10), in such a manner as to be movable in the front-rear direction. For example, a guided groove 32a extended in the front-rear direction is formed in the coupling plate 32. Meanwhile, the guide 11 is protruded downward from the inner surface of the outer case 10 and fits into the guided groove 32a in the coupling plate 32. The engagement member 30 is guided by the guide 11 and is movable in the front-rear direction.

The engagement member 30 may be pressed into the accommodation position by an elastic member. In the example depicted in FIG. 4, the attachment device 1A includes a spring 51. The spring 51 is a coil spring. One end of the spring 51 is coupled to the coupling plate 32, and the other end of the spring 51 is coupled to the rearmost portion of an upper wall section 16 of the outer case 10. The engagement member 30 is pulled into the accommodation position by the spring 51. As a result, when not in use, the engagement member 30 automatically returns from the protrusion position to the accommodation position (without requiring any user operation). Further, when placed in the protrusion position where the engagement member 30 is engaged with the engagement sections 87b, the engagement member 30 is pulled toward the accommodation position. As a result, the engagement between the engagement sections 31 of the engagement member 30 and the engagement sections 87b of the input device 80 is maintained more stably.

### [Operation Member]

As described earlier, the attachment device 1A includes the operation member 40 for operating the engagement member 30. As depicted in FIG. 4, the attachment device 1A may include left and right operation members 40. The operation members 40 may be respectively disposed, for example, on the outer sides of the two engagement sections 31 in the left-right direction. More specifically, the right operation member 40 may be disposed further to the right of the right engagement section 31, and the left operation member 40 may be disposed further to the left of the left engagement section 31.

The engagement member 30 and the operation members 40 may be accommodated in a gap formed between the inner case 20 and the inner surface of the outer case 10. More specifically, the outer case 10 may have left and right side wall sections 12 (see FIG. 4), and the inner case 20 may also have left and right side wall sections 22 (see FIG. 4). As depicted in FIG. 5A, spaces are each provided between the side wall section 12 and the side wall section 22. The engagement sections 31 and the operation members 40 may be disposed in these spaces. The coupling plate 32 of the engagement member 30 may be disposed between the lower surface of the upper wall section 16 (see FIG. 4) of the outer case 10 and the upper wall section 25 (see FIG. 4) of the inner case 20. The above-described configuration enables the cases 10 and 20 to function as guides, and allows the engagement member 30 and the operation members 40 to move smoothly.

The operation members 40 may each include a front operation section 41 (see FIGS. 4 and 5A) and a rear operation section 42 (see FIG. 4). The front operation sections 41 are used for pressing the engagement sections 31 forward. The rear operation sections 42 are used for pressing the engagement sections 31 rearward. The operation sections 41 and 42 enable the operation members 40 to move forward and rearward integrally with the engagement member 30.

The front operation sections 41 may be, for example, formed on the rear edges of the operation members 40 to hook on the rear edges of the engagement sections 31. The front operation sections 41 may press the rear edges of the engagement sections 31 forward when moving the engagement member 30 from the accommodation position to the protrusion position. The rear operation sections 42 may be, for example, formed on the front edges of the operation members 40 to hook on the front edges of the engagement sections 31. Further, the rear operation sections 42 may press the front edges of the engagement sections 31 rearward when moving the engagement member 30 from the protrusion position to the accommodation position.

The structural relation between the operation member 40 and the engagement member 30 is not limited to the above-described one. For example, a protrusion may be formed on either one of the operation member 40 and the engagement section 31, and a hole or a recess into which the protrusion fits may be formed in the other. Even when such a structural relation exists, the operation member 40 is movable forward and rearward integrally with the engagement member 30.

As depicted in FIG. 1, the operation member 40 may include an operation section 43 that is protruded outward in the left-right direction from the cable connector retaining section 2. In the example depicted in FIG. 1, an opening 12a is formed in the side wall section 12 of the outer case 10. The operation section 43 of the right operation member 40 passes through the opening 12a in the right side wall section 12 and protrudes rightward. The operation section 43 of the left operation member 40 passes through the opening 12a in the left side wall section 12 and protrudes leftward. The user can hold the left and right operation sections 43 between his/her fingers and thereby move the left and right operation members 40 and the engagement member 30 in the front-rear direction.

### [Elastic Deformation of Engagement Section and Operation Member]

As described above, the engagement section 87b is disposed inside each fitting recess 87a of the input device 80. The engagement sections 87b are provided, for example, on the outer side surfaces of the fitting recesses 87a in the left-right direction. More specifically, the right fitting recess 87a has the engagement section 87b on the right side surface of its inner surface, and the left fitting recess 87a has the engagement section 87b on the left side surface of its inner surface.

The engagement sections 31 are like leaf springs, and can be elastically deformed in the left-right direction as depicted in FIGS. 5B and 5C. In the illustrated example, the two engagement sections 31 can be elastically deformed from their initial state (the state depicted in FIG. 5B) toward the center in the left-right direction. Accordingly, the user can easily release the engagement between the engagement sections 31 and the engagement sections 87b of the input device 80 by pressing the engagement sections 31 (the operation sections 43 of the operation members 40 described later) toward the center in the left-right direction in a state where the engagement sections 31 are fitted into the fitting recesses 87a of the input device 80.

The left and right operation members 40 are positioned outside the left and right engagement sections 31 in the left-right direction. As depicted in FIG. 5C, the operation members 40 can move toward the center in the left-right direction together with the engagement sections 31. More specifically, the operation members 40 can be tilted toward the center in the left-right direction together with the engagement sections 31. As described earlier, the spaces for disposing the operation members 40 and the engagement sections 31 are provided between the side wall sections 12 of the outer case 10 and the side wall sections 22 of the inner case 20. These spaces are formed to allow the operation members 40 and the engagement sections 31 to tilt.

Specifically, as depicted in FIG. 5B, an interval G1 between the rear portions of the side wall sections 12 and 22 corresponds to the width of the rear end of the operation member 40 in the left-right direction. Meanwhile, an interval G2 between the front portions of the side wall sections 12 and 22 increases toward the front. More specifically, the side surface 22c of the side wall section 22 of the inner case 20 is tilted such that the interval G2 gradually increases toward the front. The side wall section 22 of the inner case is provided diagonally in such a manner as to enter forward toward the center, and the space between the side wall sections 12 and 22 gradually widens toward the front. Further, the interval G1 between the rear portions of the side wall sections 12 and 22 corresponds to the width of the rear end of the operation member 40 in the left-right direction. Therefore, the operation members 40 and the engagement sections 31 can be tilted around their base portions (rearmost portions). The side wall section 22 of the inner case 20 is provided diagonally in such a manner as to approach forward toward the center in the left-right direction. As a result, the space between the side wall sections 12 and 22 gradually widens toward the front.

Owing to the above-described structure of the attachment device 1A, the operation members 40 can be operated to move the engagement member 30 between the accommodation position and the protrusion position while elastically deforming the engagement sections 31. As a result, the cable connector 91 can easily be disconnected from the input device 80.

More specifically, as depicted in FIG. 5C, when the user presses the operation sections 43 of the left and right operation members 40 toward the center in the left-right direction against the elastic force of the engagement sections 31, the engagement sections 31 and the operation members 40 tilt. This releases the engagement between the tips 31a (the holes 31b; see FIG. 1) of the engagement sections 31 and the engagement sections 87b of the input device 80. Subsequently, when the user pulls the left and right operation sections 43 rearward, the engagement sections 31 come out of the fitting recesses 87a of the input device 80, and the engagement member 30 is placed in the accommodation position and disconnected from the connectors 91 and 86. When the user releases the force applied to the operation sections 43, the elastic force of the engagement sections 31 causes the engagement sections 31 and the operation members 40 to return to their original positions (positions where they are not tilted).

Further, in order to connect the cable connector 91 to the device connector 86 and engage the engagement sections 31 and 87b with each other, the user presses the operation sections 43 of the left and right operation members 40 toward the center in the left-right direction against the elastic force of the engagement sections 31, tilts the engagement sections 31 and the operation members 40, and slides the operation members 40 forward. As a result, the tips 31a (the holes 31b; see FIG. 1) of the engagement sections 31 are inserted into the fitting recesses 87a while being separated from the engagement sections 87b of the input device 80 toward the center in the left-right direction.

As depicted in FIG. 5A, the rearmost sections (front operation sections 41) of the operation members 40 may respectively have protrusions 41a that are protruded toward the side wall sections 22 of the inner case 20. Such a configuration can reduce the friction between the operation members 40 and the side wall sections 22 and provide smooth movement (frontward and rearward movement and tilt) of the operation members 40. Further, the rearmost sections (front operation sections 41) of the operation members 40 may respectively have protrusions 41b that are protruded toward the side wall sections 12 of the outer case 10. Such a configuration can reduce the friction between the operation members 40 and the side wall sections 12 and provide smooth movement (frontward and rearward movement and tilt) of the operation members 40.

Moreover, the operation members 40 may respectively have protrusions 40a that are disposed at the forefront of the operation members 40 and protruded toward the side wall sections 12 of the outer case 10. Such a configuration can reduce the friction between the operation members 40 and the side wall sections 12 and provide smooth movement (frontward and rearward movement) of the operation members 40.

As depicted in FIG. 4, the inner case 20 may have bottom sections 26 that extend outward in the left-right direction from the lower edges of the left and right side wall sections 22. The lower sides of the spaces accommodating the operation members 40 and the engagement sections 31 may be defined by the bottom sections 26. Further, the upper side of these spaces may be defined by the upper wall section 16 of the outer case 10.

The operation members 40 may be pressed toward one side in the up-down direction. For example, the operation members 40 may be pressed downward against the bottom sections 26 of the inner case 20. Such a configuration can reduce the rattling of the operation members 40 in the up-down direction. As depicted in FIG. 4, the upper edges of the operation members 40 may respectively have spring sections 44 that extend in the front-rear direction. The spring sections 44 may press the operation members 40 downward. Such a configuration can press the operation members 40 against the bottom sections 26 of the inner case 20 and prevent the operation members 40 from rattling in the up-down direction. The structure for suppressing the rattling of the operation members 40 is not limited to the example depicted in FIG. 4.

### [Positioning of Cable Connector]

The inner case 20 has the connector accommodation chamber A as described earlier. The inner case 20 may have a stopper section (positioning section) that defines the position of the cable connector 91 within the connector accommodation chamber A.

As depicted in FIG. 5A, the forward movement of the cable connector 91 is defined, for example, by the front wall section 23 of the inner case 20. Specifically, a lower edge 23a (see FIG. 4) of the front wall section 23 may function as a stopper that restricts the forward movement of the cable connector 91. The lower edge 23a corresponds to the front surface of the insulating section 91a of the cable connector 91. The rear wall section 24 of the inner case 20 is formed along the rear surface of the insulating section 91a. As depicted in FIG. 4, the rear wall section 24 of the inner case 20 may have, for example, a stopper protrusion 24b on its inner surface. The stopper protrusion 24b corresponds to the rear surface of the insulating section 91a, and may restrict the rearward movement of the cable connector 91.

The distance between the stopper protrusion 24b and the lower edge 23a of the front wall section 23 is set according to the front-rear dimension of the insulating section 91a of the cable connector 91. Further, the distance between the left and right side wall sections 22 of the inner case 20 is set according to the left-right dimension of the insulating section 91a. That is, the dimensions of the connector accommodation chamber A are set according to the dimensions of the insulating section 91a of the cable connector 91. This results in preventing the disconnection of the connectors 91 and 86. The structure defining the position of the cable connector 91 within the inner case 20 is not limited to the example described here. For example, the rearward movement of the cable connector 91 may be restricted by the inner surface of the rear wall section 24 itself instead of by the stopper protrusion 24b.

As described above, the inner case 20, which is a single member, has two regions, namely, the region for restricting the forward movement of the cable connector 91 and the region for restricting the rearward movement of the cable connector 91. This structure can improve the positional accuracy of the cable connector 91 in the cable connector retaining section 2 as compared to, for example, a structure in which these two regions are formed on separate members, and can suppress the rattling of the cable connector 91 in the front-rear direction.

As described above, the operation members 40 and the engagement sections 31 are disposed between the side wall sections 12 of the outer case 10 and the side wall sections 22 of the inner case 20, and the movement of the operation members 40 and the engagement sections 31 is guided by the side wall sections 12 and 22. As is obvious from the foregoing description, the inner case 20 in the attachment device 1A has the function of defining the position of the cable connector 91 and the function of guiding the movement of the engagement sections 31 and the operation members 40. This aims for reducing the number of parts.

### [Outer Case]

The front wall section 13 of the outer case 10 has a front surface 13b. As depicted in FIG. 1, the front surface 13b may be tilted or curved to match the surface of the input device 80 (the surface on which the device connector 86 is mounted). The posture of the attachment device 1A with respect to the input device 80 can be defined by tilting or curving the front surface 13b in such a manner. For example, it is possible to prevent the attachment device 1A from being attached to the input device 80 while the attachment device 1A is turned upside down.

As depicted in FIG. 3A, a recess 14b through which the cable 90 passes may be formed in a rear wall section 14 of the outer case 10. The hinge section 18 is provided on the lower edge of the front wall section 13 as described earlier. This structure makes it possible to fit the terminal section 91b into an opening formed in the front wall sections 13 and 23 of the cable connector retaining section 2 while the cable connector 91 tilted, then dispose the cable connector 91 in the connector accommodation chamber A, and place the cable 90 in the recess 14b.

The cable connector retaining section 2 may have a guide for indicating the positions (protrusion position and accommodation position) of the engagement member 30 to the user. For example, as depicted in FIG. 1, a hole 16c may be formed through the upper wall section 16 of the outer case 10. When the engagement member 30 is in the protrusion position, the engagement member 30 is partially exposed through the hole 16c. When the engagement member 30 is in the accommodation position, the engagement member 30 is not exposed through the hole 16c. This allows the user to correctly recognize the position of the engagement member 30. It should be noted that, contrary to the example described here, the engagement member 30 may be partially exposed through the hole 16c when the engagement member 30 is in the accommodation position, and may not be exposed through the hole 16c when the engagement member 30 is in the protrusion position.

### [Cover]

As depicted in FIG. 3A, the inner surface of the cover 19 (the upper surface of the cover 19 when it is closed) may be provided with a cushion 19d. The cushion 19d suppresses the rattling of the cable connector 91 in the connector accommodation chamber A.

As depicted in FIG. 3A, the cover 19 may have engagement sections 19a and 19b for fixing the cover 19 in the closed position. Each of the engagement sections 19a is, for example, shaped like a claw and formed on the rear edge of the cover 19. Each of cover fastening sections 14a shaped like a recess into which the claw fits may be formed on the rear wall section 14 of the outer case 10. Each of the engagement sections 19b is positioned between the front and rear edges of the cover 19, and protruded upward. Each of the tips of the engagement sections 19b may also be shaped like a claw. Recesses 22b into which the engagement sections 19b fit may be formed in the lower edges of the left and right side wall sections 22 of the inner case 20. The tips (claws) of the engagement sections 19b hook on the inner surfaces of the recesses 22b.

### [Operating Procedure of Attachment Device]

The procedure for connecting the cable connector 91 to the input device 80 by using the attachment device 1A is as described below. First, the cable connector 91 is attached to the connector retaining section 2. More specifically, the cable connector 91 is fitted into the connector accommodation chamber A. Then, the cover 19 is closed. Next, the cable connector 91 is connected to device connector 86 of the input device 80. Subsequently, the operation members 40 are advanced from the accommodation position to the protrusion position. In this instance, the user holds the left and right operation sections 43 between his/her fingers, and moves the left and right operation members 40 and the engagement member 30 forward while elastically deforming the engagement sections 31. As a result, the tips 31a of the engagement sections 31 fit into the fitting recesses 87a of the input device 80. When the user releases the force applied to the operation members 40, the engagement sections 31 return to their original positions by its own elastic force, thereby completing the engagement between the engagement sections 31 and the engagement sections 87b.

The procedure for disconnecting the cable connector 91 from the input device 80 is as described below. First, as depicted in FIG. 5C, when the user presses the operation sections 43 of the left and right operation members 40 toward the center in the left-right direction against the elastic force of the engagement sections 31, the engagement sections 31 and the operation members 40 tilt.

As a result, the tips 31a (holes 31b; see FIG. 1) of the engagement sections 31 are disengaged from the engagement sections 87b of the input device 80. Subsequently, when the user pulls the left and right operation sections 43 rearward, the engagement sections 31 come out of the fitting recesses 87a of the input device 80, and the engagement member 30 is placed in the accommodation position and disconnected from the connectors 91 and 86.

### Second Example of Attachment Device

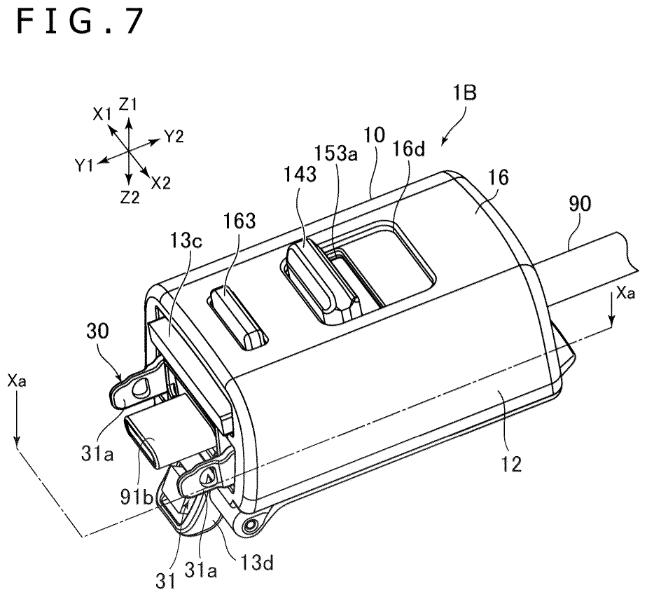

A second example of the attachment device proposed by the present disclosure will now be described with reference to FIGS. 7 to 12B, which illustrate an attachment device 1B as the second example. The attachment device 1B is described below, focusing on the differences from the attachment device 1A. For the structural elements not described in conjunction with the attachment device 1B, the corresponding elements of the attachment device 1 may be applied.

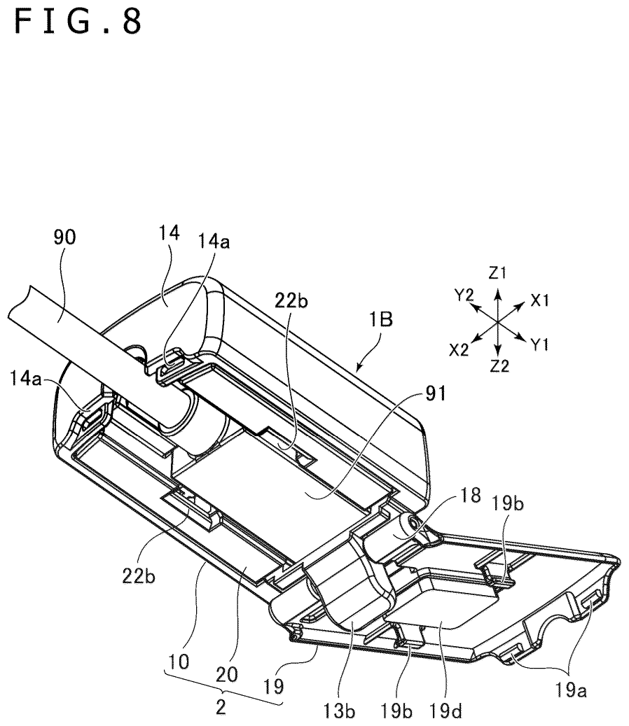

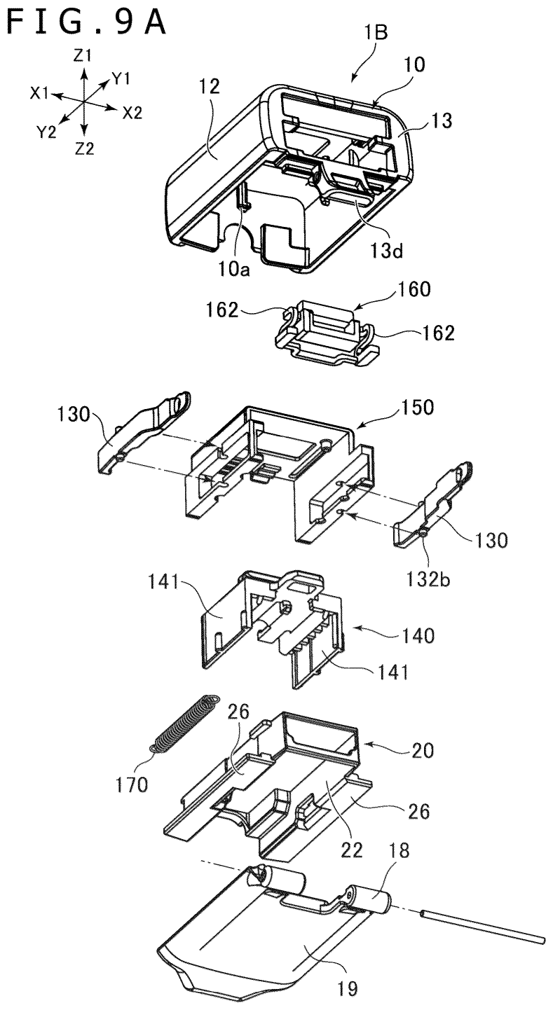

The attachment device 1B includes the connector retaining section 2, as is the case with the attachment device 1A. The connector retaining section 2 has the outer case 10, the inner case 20, and the cover 19 (see FIG. 8).

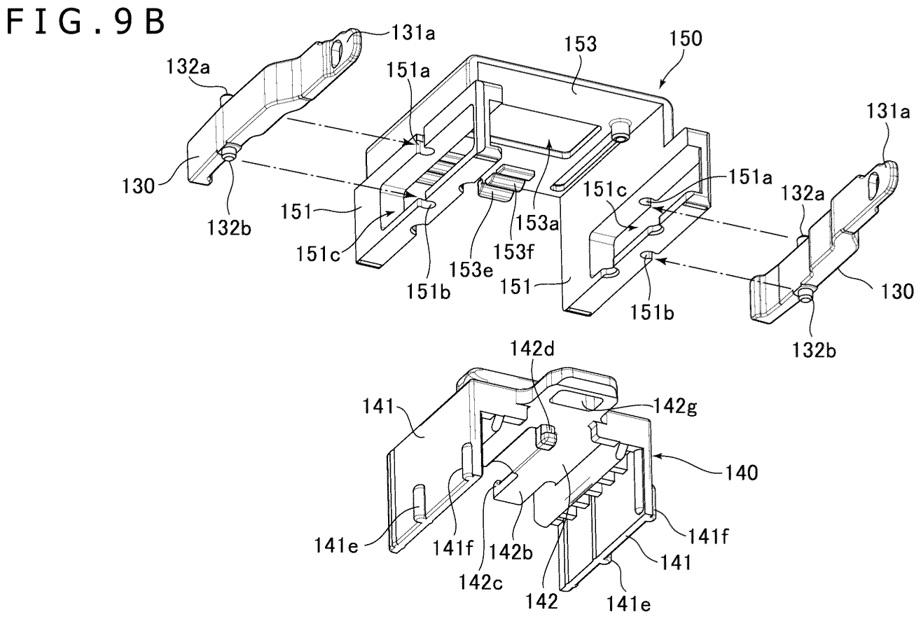

Further, as depicted in FIG. 9, the attachment device 1B also includes engagement members 130 for engaging with the input device 80. The attachment device 1B includes a right engagement member 130 and a left engagement member 130. These members are formed separately from each other. Further, the attachment device 1B includes an operation member 140 and a movable support member 150. The operation member 140 and the movable support member 150 enable the engagement members 130 to move in the front-rear direction, engage with the input device 80, and disengage from the input device 80.

The support members 130, the operation member 140, and the movable support member 150 are accommodated in the gap between the outer case 10 and the inner case 20, as is the case with the engagement member 30 and the operation members 40, which are described earlier.

### [Engagement Members]

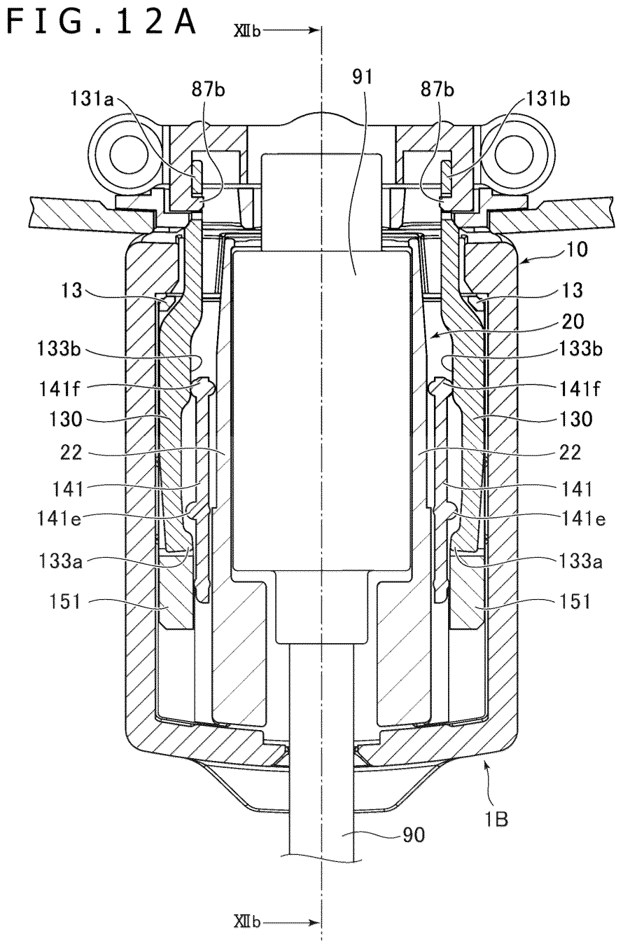

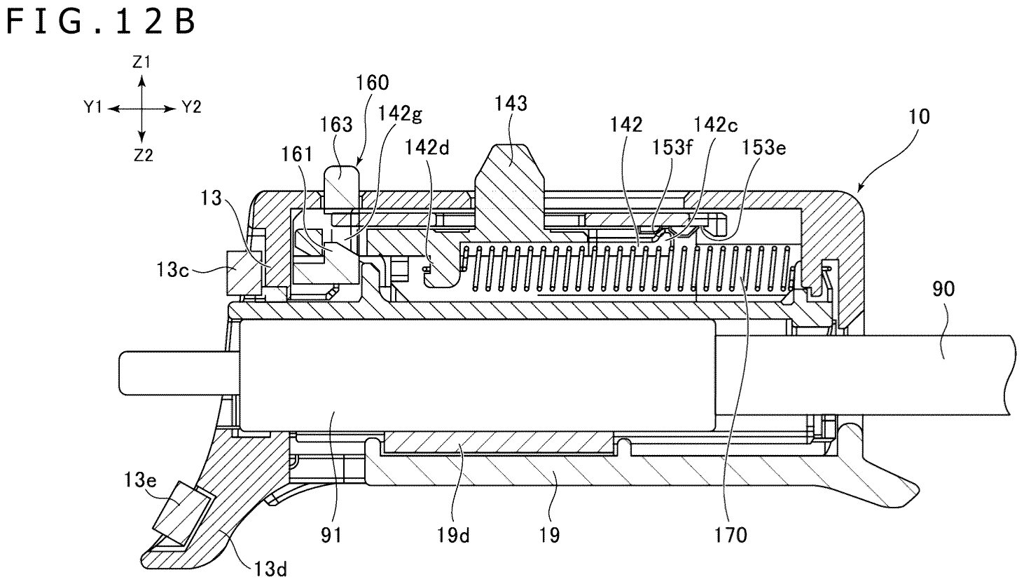

As depicted in FIG. 9B, the engagement members 130 include engagement sections (tips) 131a for engaging with the engagement sections 87b of the input device 80, similarly to the engagement member 30. The engagement sections 87b are protrusions (see FIG. 12A), and the engagement sections 131a have holes into which the engagement sections 87b fit. Alternatively, however, recesses into which the engagement sections 87b fit may be formed in the engagement sections 131a. Conversely, the engagement sections 131a may be protrusions, and the engagement sections 87b may be recesses or holes.

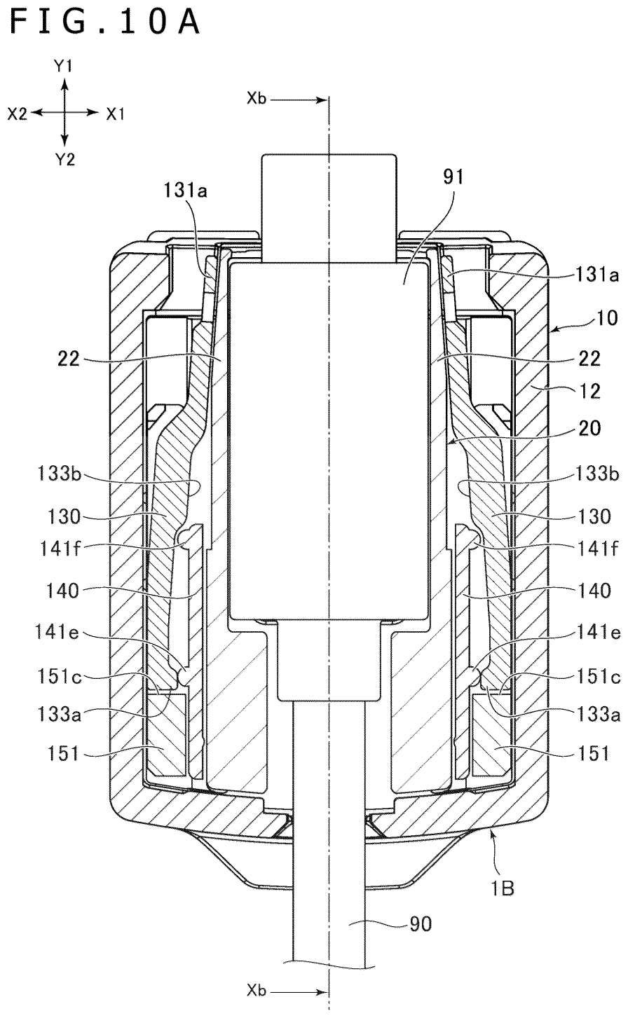

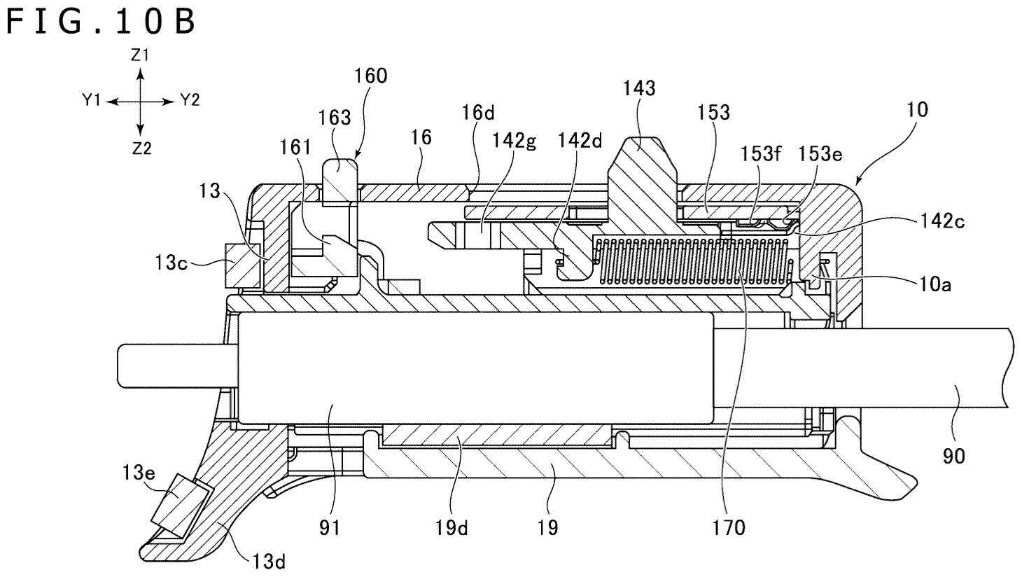

The engagement members 130 are movable in the front-rear direction between two positions, namely, a protrusion position where the engagement sections 131a are protruded forward from the front surface of the connector retaining section 2 (the front surface of the outer case 10), and an accommodation position where the engagement sections 131a are accommodated in the outer case 10. The protrusion position is the position of the engagement members 130 depicted in FIGS. 7, 11, and 12A. The accommodation position is the position of the engagement members 130 depicted in FIG. 10A.

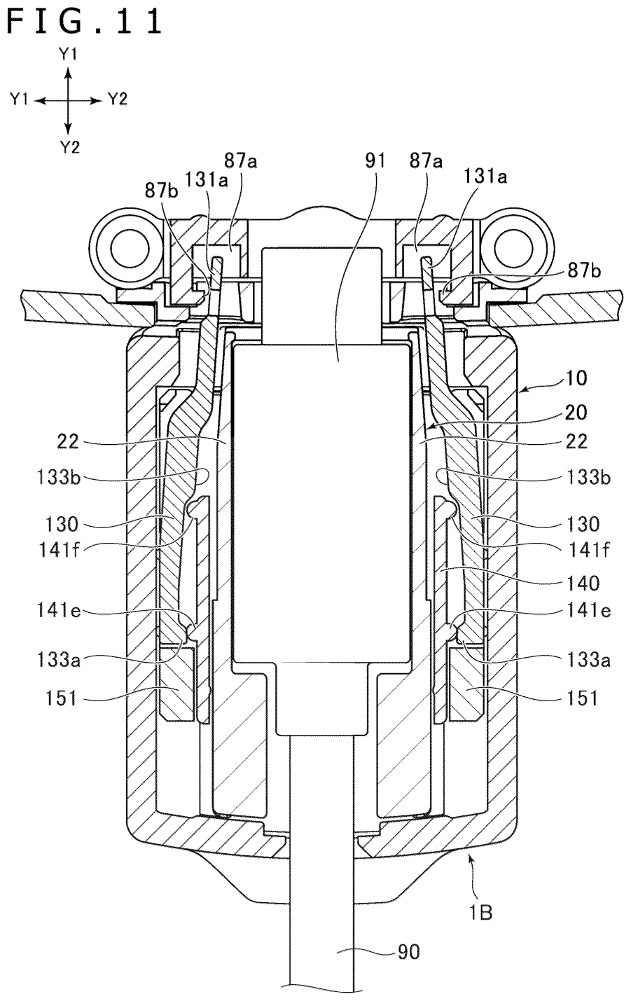

The engagement members 130 are supported in such a manner that the engagement sections 131a move in the left-right direction. More specifically, the engagement sections 131a are allowed to move in the left-right direction without requiring elastic deformation of the engagement members 130. The engagement members 130 are movable between two positions. One position provides an engaged posture (FIG. 12A), and the other position provides a disengaged posture (FIG. 11). The engaged posture (FIG. 12A) is a posture in which the engagement sections 131a engage with the input device 80, and the disengaged posture (FIGS. 10A and 11) is a posture in which the engagement sections 131a do not engage with the input device 80.

In the illustrated example, the disengaged posture (FIGS. 10A and 11) is defined as being provided by a position closer to the center in the left-right direction than that of the engaged posture (FIG. 12A). Stated differently, the distance between the engagement sections 131a of the left and right engagement members 130 is longer when the engagement members 130 are in the engaged posture than when the engagement members 130 are in the disengaged posture. Therefore, when the engagement members 130 are in the engaged posture, the engagement sections 131a engage with the engagement sections 87b of the input device 80.

It should be noted that, contrary to the illustrated example, the distance between the engagement sections 131a of the left and right engagement members 130 may be longer when the engagement members 130 are in the disengaged posture than when the engagement members 130 are in the engaged posture. In such a case, the engagement sections 87b of the input device 80 may be disposed inside the left and right engagement members 130.

### [Movable Support Member]

As depicted in FIG. 9B, the movable support member 150 has left and right support walls 151. Further, the movable support member 150 has a coupling wall 153 that couples the left and right support walls 151 together. The left and right engagement members 130 are respectively supported by the left and right support walls 151 in such a manner that the left and right engagement members 130 are allowed to move between the position for the engaged posture and the position for the disengaged posture.

The engagement members 130 are supported by the support walls 151 through shaft sections, for example. In the illustrated example, the engagement members 130 each have an upwardly protruding shaft section 132a and a downwardly protruding shaft section 132b. The shaft sections 132a and 132b fit into the support walls 151 to form support recesses 151a and 151b for supporting the shaft sections 132a and 132b. The engagement members 130 are movable around the shaft sections 132a and 132b between the position for the engaged posture and the position for the disengaged posture.

Since the engagement members 130 move around the shaft sections 132a and 132b, elastic deformation of the engagement members 130 is not required, unlike the engagement member 30 depicted, for example, in FIG. 4. The engagement members 130 may be formed, for example, by resin, unlike the engagement member 30. The engagement members 130 may be formed by metal.

As depicted in FIG. 9B, openings 151c are formed in the support walls 151. The support members 130 are disposed inside the openings 151c and exposed toward the inside of the movable support member 150. The support members 130 are operated by the operation member 140 disposed inside the movable support member 150.

It should be noted that the support structure for the engagement members 130 is not limited to the one depicted in the illustrated example. For example, shaft sections may be formed inside the openings 151c in the support walls 151, and recesses into which the shaft sections fit may be formed in the engagement members 130.

The movable support member 150 is allowed to move (slide) in the front-rear direction. In the illustrated example, the movable support member 150 is disposed between the outer case 10 and the inner case 20, and is slidable in the front-rear direction.

Since the support members 130 are supported by the movable support member 150 through the shaft sections 132a and 132b, the engagement members 130 are movable in the front-rear direction together with the movable support member 150. Specifically, the movable support member 150 is movable in the front-rear direction between an accommodation support position (FIG. 10A) and a protrusion support position (FIGS. 11 and 12A). The accommodation support position is a position for placing the engagement members 130 in the accommodation position. Meanwhile, the protrusion support position is a position for placing the engagement members 130 in the protrusion position.

### [Operation Member]

As depicted in FIG. 9B, the operation member 140 has left and right operation walls 141. Operation pressing sections 141e and 141f are formed on the outer surfaces of the operation walls 141 to move the engagement members 130 to the position for the engaged posture and to the position for the disengaged posture. Further, the operation member 140 has a coupling wall 142 that couples the left and right operation walls 141 together. The operation member 140 is disposed inside the movable support member 150 and is accommodated in the gap between the outer case 10 and the inner case 20 together with the movable support member 150 and the support members 130.

Further, the operation member 140 has an operation reception section 143 as depicted in FIG. 7. The operation reception section 143 is exposed from the outer surface of the attachment device 1B to receive a user's operation. In the illustrated example, an opening 16d is formed in the upper wall section 16 of the outer case 10. Moreover, an opening 153a is formed in the coupling wall 153 of the movable support member 150. The operation reception section 143 is protruded upward through the opening 16d and the opening 153a.

The operation member 140 is movable in the front-rear direction between an accommodation operation position (FIG. 10A), a disengagement operation position (FIG. 11), and an engagement operation position (FIG. 12A). The accommodation operation position, the disengagement operation position, and the engagement operation position are defined in the order named, from the rear side to the front side (toward the input device 80).

As depicted in FIG. 12A, the engagement operation position is a position for placing the engagement members 130 in the engaged posture in the protrusion position. When the operation member 140 is in the engagement operation position, the operation member 140 presses the engagement members 130 in such a manner as that the left and right engagement sections 131a extend outward in the left-right direction, and places the engagement members 130 in the engaged posture.

As depicted in FIG. 10A, the accommodation operation position is a position for placing the engagement members 130 in the accommodation position. More specifically, when the operation member 140 is in the accommodation operation position, the movable support member 150 is placed in the accommodation support position, and the engagement sections 131a of the engagement members 130 are accommodated in the outer case 10. In this instance, the operation member 140 presses the engagement members 130 in such a manner that the left and right engagement sections 131a approach the center in the left-right direction, and places the engagement members 130 in the disengaged posture.

As depicted in FIG. 11, the disengagement operation position is defined between the engagement operation position and the accommodation operation position. When the operation member 140 is in the disengagement operation position, the movable support member 150 is placed in the protrusion support position, and the engagement members 130 are placed in the protrusion position. In this instance, the relative positions of the engagement members 130 and the operation member 140 are the same as those when the operation member 140 is in the accommodation operation position. Therefore, the operation member 140 presses the engagement members 130 in such a manner that the left and right engagement sections 131a approach the center in the left-right direction, and places the engagement members 130 in the disengaged posture.

### [Structure for Providing Disengaged Posture of Engagement Members]

As described above, when the operation member 140 is in the accommodation operation position, the operation member 140 presses the engagement members 130 in such a manner as to place the engagement members 130 in the disengaged posture. As depicted in FIG. 10A, the engagement members 130 each have a pressing target section 133a. The pressing target sections 133a are each positioned rearward of the shaft sections 132a and 132b. Meanwhile, the operation member 140 has the operation pressing sections 141e. When the operation member 140 is in the accommodation operation position, the operation pressing sections 141e press the pressing target sections 133a (see FIG. 10A). Consequently, the left and right engagement members 130 are moved toward the engagement sections 131a at the tips of the left and right engagement members 130 in such a manner as to gradually decrease the distance to the engagement sections 131a.

As depicted in FIG. 10A, the pressing target sections 133a of the engagement members 130 are, for example, protruded toward the center in the left-right direction (toward the operation walls 141 of the operation member 140). The pressing target sections 133a may be formed on the rear ends of the engagement members 130. The operation pressing sections 141e of the operation member 140 may be, for example, protruded outward in the left-right direction (toward the engagement members 130).

As depicted in FIG. 10A, the operation member 140 includes the operation pressing sections 141f, which are positioned forward of the operation pressing sections 141e. When the operation member 140 is in the accommodation operation position, the operation pressing sections 141f do not interfere with the engagement members 130.

[Structure of Engagement between Operation Member and Movable Support Member]

The operation member 140 and the movable support member 150 are engaged with each other in such a manner as to move integrally between the engagement operation position and the disengagement operation position. For example, as depicted in FIG. 9B, a rear engagement recess 153e and a front engagement recess 153f may be formed at the rear of the coupling wall 153 of the movable support member 150. A protrusion is formed between the two engagement recesses 153e and 153f. Meanwhile, the coupling wall 142 of the operation member 140 has a leaf spring section 142b that is extended rearward. An operation protrusion 142c, which is protruded toward the coupling wall 153 of the movable support member 150, may be formed on the leaf spring section 142b. The operation protrusion 142c may be formed on the rear end of the leaf spring section 142b.

As depicted in FIG. 10B, when the operation member 140 is in the accommodation operation position, the operation protrusion 142c of the operation member 140 is engaged with the rear engagement recess 153e of the movable support member 150. Therefore, when the operation member 140 advances toward the disengagement operation position (FIG. 11), the movable support member 150 advances together with the operation member 140, and is placed in the protrusion support position. Conversely, when the operation member 140 in the disengagement operation position (FIG. 11) moves rearward, the movable support member 150 retreats together with the operation member 140 due to the engagement between the operation protrusion 142c and the rear engagement recess 153e. Since the engagement members 130 are supported by the movable support member 150, the movable support member 150 and the engagement members 130 advance and retreat together with the operation member 140.

It should be noted that the structure of engagement between the operation member 140 and the movable support member 150 is not limited to the one depicted in the illustrated example. For example, a leaf spring section may be formed on the movable support member 150 to form a protrusion on the leaf spring section. In such a case, a recess corresponding to the rear engagement recess 153e and the front engagement recess 153f may be formed in the operation member 140. Further, in the illustrated example, the structure of engagement is formed on the coupling wall 142 and on the coupling wall 153. However, the structure of engagement may alternatively be formed on the left and right operation walls 141 and on the left and right support walls 151.

### [Structure for Providing Engaged Posture of Engagement Members]

When the operation member 140 moves between the disengagement operation position (FIG. 11) and the engagement operation position (FIG. 12A), a change occurs in the relative positions of the operation member 140 and the engagement members 130. More specifically, when the operation member 140 in the disengagement operation position (FIG. 11) advances, the forward movement of the movable support member 150 is restricted by the connector retaining section 2 (specifically, by the front wall section 13 of the outer case 10). Consequently, the operation member 140 moves forward relative to the movable support member 150 and the engagement members 130, and is placed in the engagement operation position (FIG. 12A).

When the operation member 140 is in the engagement operation position, the operation member 140 presses the engagement members 130 to place the engagement members 130 in the engaged posture. As depicted, for example, in FIG. 12A, the operation member 140 includes the operation pressing sections 141f. Meanwhile, the engagement members 130 each have a pressing target inner surface 133b. The pressing target inner surfaces 133b are each formed forward of the shaft sections 132a and 132b. When the operation member 140 is placed in the engagement operation position, the operation pressing sections 141f press the pressing target inner surfaces 133b outward in the left-right direction. As a result, the engagement members 130 are placed in the engaged posture.

When the operation member 140 is in the engagement operation position, the operation pressing sections 141e of the operation member 140 are positioned forward of the pressing target sections 133a of the engagement members 130. Therefore, the engagement members 130 are allowed to move from the position for the disengaged posture to the position for the engaged posture.

As depicted in FIG. 12A, the operation pressing sections 141f may be protrusions that are protruded toward the engagement members 130, as is the case with the operation pressing sections 141e. The operation pressing sections 141f may be formed on the front edges of the operation walls 141 of the operation member 140. The pressing target inner surfaces 133b may be bulged more inward than the other portions of the inner surfaces of the engagement members 130. The inner surfaces of the engagement members 130 may each have a slope behind the pressing target inner surfaces 133b.

When the operation member 140 is in the engagement operation position, the operation pressing sections 141f restrict the engagement members 130 from moving to the position for the disengaged posture. This ensures that the engagement members 130 are placed in the engaged posture. As a result, the engagement members 130 properly engage with the input device 80. Therefore, in a case where, for example, the engagement sections 87b are not fitted into the holes formed in the engagement sections 131a, the operation member 140 is unable to reach the engagement operation position. Consequently, operating personnel can recognize that the engagement members 130 are not properly engaged with the input device 80.

### [Locking Member]

As depicted in FIG. 10B, a locking member 160 is disposed between the outer case 10 and the inner case 20. When the operation member 140 is placed in the engagement operation position (see FIG. 12B), the locking member 160 engages with the operation member 140 and restricts the rearward movement of the operation member 140.

As depicted, for example, in FIG. 12B, an engagement hole 142g may be formed in the forefront of the operation member 140, and a claw section 161 may be formed on the locking member 160. Further, when the operation member 140 is placed in the engagement operation position, the claw section 161 may fit into the engagement hole 142g to restrict the rearward movement of the operation member 140.

The locking member 160 is elastically deformable to allow the claw section 161 to move up and down. The left and right sections of the locking member 160 may each be provided, for example, with a spring section 162 (see FIG. 9A). Further, the spring section 162 may elastically deform to allow the claw section 161 to move up and down. The locking member 160 has an operation reception section 163 (see FIG. 7). The operation reception section 163 is protruded upward from an opening formed in the upper wall section 16 of the outer case 10. When the operation reception section 163 is pressed down, the claw section 161 disengages from the engagement hole 142g.

As depicted in FIG. 10B, the attachment device 1B may include a spring 170. The spring 170 pulls the operation member 140 rearward. The front end of the spring 170 may engage, for example, with a spring engagement section 142d (see FIG. 10B) formed on the operation member 140, and the rear end of the spring 170 may engage, for example, with a spring engagement section 10a (see FIG. 10B) formed on the inner surface of the outer case 10.

When the operation reception section 163 of the locking member 160 is pressed down to disengage the claw section 161 from the engagement hole 142g, the operation member 140 is pulled rearward by the action of the spring 170. As a result, the operation member 140 returns from the engagement operation position to the accommodation operation position through the disengagement operation position.

### [Others]

As depicted in FIG. 7, the connector retaining section 2 may have a cushion 13c on the front surface thereof. Further, the connector retaining section 2 may have a support section 13d that is protrusible and disposed at the forefront of the cable connector retaining section 2. A cushion 13e may be attached to the front surface of the support section 13d. When the attachment device 1B is attached to the input device 80, the cushions 13c and 13e may come into contact with the outer surface of the input device 80.

### [Operating Procedure of Attachment Device]

The procedure for operating the attachment device 1B will now be described. First, the operating procedure to be performed for connecting the cable connector 91 to the input device 80 is described below.

In the initial state, the operation member 140 is placed in the accommodation operation position, which is defined as the rearmost position among three positions, as depicted in FIG. 10A. The movable support member 150 is placed in the accommodation support position, and the engagement members 130 are placed in the accommodation position. The operation pressing sections 141e formed on the left and right sides of the operation member 140 press the pressing target sections 133a of the left and right engagement members 130 outward. Therefore, the engagement members 130 are placed in the disengaged posture.

When the user presses the operation reception section 143 (see FIG. 7) of the operation member 140 forward, the operation member 140 moves to the disengagement operation position, which is the middle position among the three positions, as depicted in FIG. 11. In this instance, the operation protrusion 142c (FIGS. 9B and 10B) formed at the rear of the operation member 140 engages with the rear engagement recess 153e (FIGS. 9B and 10B) of the movable support member 150. As a result, the movable support member 150 moves forward together with the operation member 140, and is placed in the protrusion support position. At the same time, the engagement members 130 are placed in the protrusion position, so that the front ends (engagement sections 131a) of the engagement members 130 are protruded from the front surface of the connector retaining section 2. In this instance, the relative positions of the engagement members 130 and the operation member 140 remain in the initial state. Therefore, the engagement members 130 are continuously positioned to remain in the disengaged posture.

When the user presses the operation reception section 143 of the operation member 140 further forward, the operation member 140 moves to the engagement operation position, which is the foremost position among the three positions, as depicted in FIG. 12A. When the movable support member 150 is placed in the protrusion support position (FIG. 11), the front end of the movable support member 150 collides with the inner surface (front wall section 13) of the outer case 10. Therefore, when the operation member 140 moves forward toward the engagement operation position, the forward movement of the movable support member 150 is restricted by the outer case 10. As a result, the operation member 140 moves forward relative to the engagement members 130 and the movable support member 150. Then, as depicted in FIG. 12A, the operation pressing sections 141f formed on the left and right sides of the operation member 140 press the pressing target inner surfaces 133b of the left and right engagement members 130 outward in the left-right direction. Consequently, the engagement members 130 are placed in the engaged posture to engage with the input device 80. In this instance, the engagement hole 142g of the operation member 140 engages with the claw section 161 of the locking member 160.

When the operation member 140 is placed in the engagement operation position, the operation protrusion 142c formed at the rear of the operation member 140 engages with the front engagement recess 153f of the movable support member 150, as depicted in FIG. 12B.

The operating procedure to be performed for disconnecting the cable connector 91 from the input device 80 will now be described.

When the user presses the operation reception section 163 of the locking member 160, the claw section 161 disengages from the engagement hole 142g, and the operation member 140 is pulled rearward by the action of the spring 170. When the operation member 140 attempts to move rearward from the engagement operation position while the engagement sections 131a of the engagement members 130 are engaged with the input device 80, the operation member 140 moves rearward relative to the engagement members 130.

Then, the operation member 140 is placed in the disengagement operation position (FIG. 11), so that the left and right operation pressing sections 141e of the operation member 140 press the pressing target sections 133a of the left and right engagement members 130 outward. As a result, the engagement members 130 are placed in the disengaged posture to disengage the engagement sections 131a from the input device 80.

As described above, the operation member 140 presses the rear pressing target sections 133a of the engagement members 130 outward in the left-right direction. This restricts the engagement members 130 from moving to the position for the engaged posture. As a result, the engagement members 130 are properly disengaged from the input device 80.

Further, when the operation member 140 is placed in the disengagement operation position (FIG. 11), the operation protrusion 142c formed at the rear of the operation member 140 moves from the front engagement recess 151f of the movable support member 150 to the rear engagement recess 151e.

The operation member 140 is pulled further rearward by the spring 170. Then, the movable support member 150 moves rearward together with the operation member 140 due to the engagement between the operation protrusion 142c of the operation member 140 and the rear engagement recess 151e of the movable support member 150. As a result, the movable support member 150 and the engagement members 130 are placed, respectively, in the accommodation support position and the accommodation position, and the operation member 140 is placed in the accommodation operation position.

As described above, in the examples depicted in FIGS. 7 to 12B, when the user simply presses the operation reception section 163 of the locking member 160, the operation member 140, the engagement members 130, and the movable support member 150 return to their initial states.

### [Significance of Spring]

The spring 170 prevents the operation member 140 from stopping at an intermediate position (i.e., the disengagement operation position) when the operation member 140 is moved rearward from the engagement operation position.

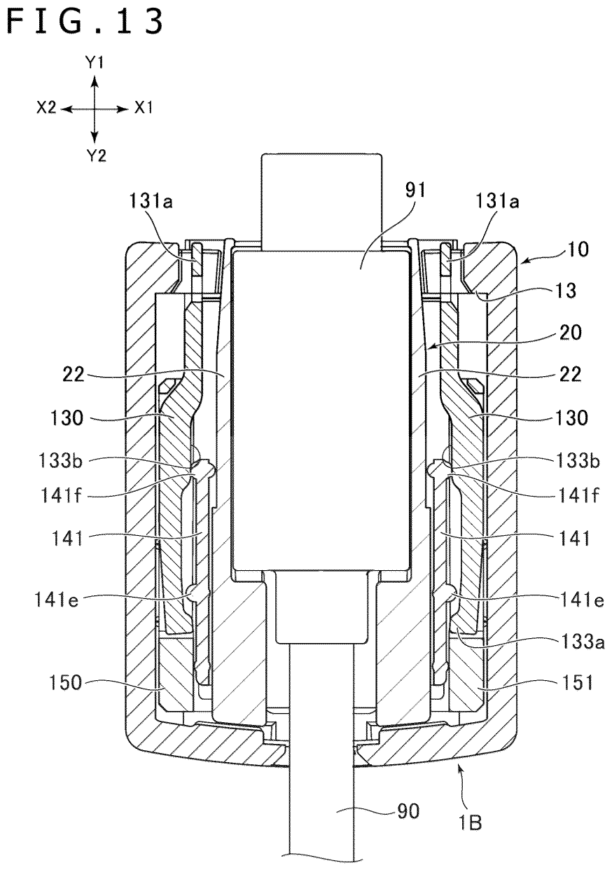

Without the spring 170, the following situation may occur. In some cases, the user may press the operation member 140 forward without the input device 80 to place the operation member 140 in the engagement operation position (FIG. 12A) and place the engagement members 130 in the engaged posture. In this case, when the user returns the operation member 140 rearward to the disengagement operation position (FIG. 11), the movable support member 150 moves rearward together with the operation member 140 due to the engagement between the operation protrusion 142c (FIG. 12B) of the operation member 140 and the front engagement recess 151f of the movable support member 150. Then, as depicted in FIG. 13, the movable support member 150 is placed in the accommodation support position, and the tips (the engagement sections 131a) of the engagement members 130 are accommodated in the outer case 10. In this instance, the engagement members 130 remain in the engaged posture. Subsequently, when the user slides the operation member 140 forward again to connect the cable connector 91 to the input device 80, the engagement sections 131a at the front ends of the engagement members 130 interfere with the outer surface of the input device 80, so that the engagement members 130 do not properly engage with the input device 80.

However, using the spring 170 makes it possible to prevent the operation member 140 from remaining in a position (the disengagement operation position) between the engagement operation position and the accommodation operation position. Therefore, as described with reference to FIG. 13, the engagement sections 131a at the front ends of the engagement members 130 can be prevented from interfering with the outer surface of the input device 80.

### CONCLUSIONS

(1) As described above, the attachment devices 1A and 1B include the engagement members 30 and 130, respectively, and the cable connector retaining section 2, the engagement members 30 and 130 being disposed on the cable connector retaining section 2. The engagement members 30 and 130 have the engagement sections 31 and 131a, respectively, for engaging with the input device 80. The engagement member 30 is movable between the protrusion position where the engagement sections 31 and 131a are protruded from the cable connector retaining section 2 and the accommodation position where the engagement sections 31 and 131a are accommodated in the cable connector retaining section 2.

The above-described structures of the attachment devices 1A and 1B make it possible to improve the stability of connection between the input device 80 and the cable 90. Further, moving the engagement members 30 and 130 from the accommodation position to the protrusion position after completion of connection between the cable connector 91 and the device connector 86 causes the engagement sections 31 and 131a to engage with the engagement sections 87b of the input device 80. This eliminates the need to simultaneously perform the alignment of the cable connector 91 with the device connector 86 and the alignment of the engagement sections 31 and 131a with the fitting recesses 87a formed in the input device 80. This results in facilitating the operation for engaging the engagement sections 31 and 131a with the engagement sections 87b of the input device 80.

(2) In the attachment device 1B having the structure described in (1), the engagement members 130 in the protrusion position are movable between the position for the engaged posture, in which the engagement sections 131a engage with the input device 80, and the position for the disengaged posture, in which the engagement sections 131a do not engage with the input device 80. The operation member 140 is movable relative to the engagement members 130 between the engagement operation position (FIG. 12A) for placing the engagement members 130 in the engaged posture and the disengagement operation position (FIG. 11) for placing the engagement members 130 in the disengaged posture.

(3) In the structure described in (2), the operation member 140 in the disengagement operation position (FIG. 11) presses the pressing target sections 133a of the engagement members 130 to place the engagement members 130 in the disengaged posture, and the operation member 140 in the engagement operation position (FIG. 12A) presses the pressing target inner surfaces 133b of the engagement members 130 to place the engagement members 130 in the engaged posture. Consequently, the engagement members 130 can be placed in the engaged posture and in the disengaged posture without requiring elastic deformation of the engagement members 130. This ensures that the attachment device 1B is properly attached to the input device 80.

(4) In the structure described in (2) or (3), the engagement members 130 are supported in such a manner that the engagement sections 131a move in the left-right direction. The operation member 140 is movable relative to the engagement members 130 in the front-rear direction.

(5) In the structure described in any one of (2) to (4), the movable support member 150 is movable between the accommodation support position (FIG. 10A) for placing the engagement members 130 in the accommodation position and the protrusion support position (FIG. 12A) for placing the engagement members 130 in the protrusion position. The operation member 140 is movable between the accommodation operation position, the disengagement operation position, and the engagement operation position. The operation member 140 placed in the accommodation operation position places the movable support member 150 in the accommodation support position, and the operation member 140 placed in the disengagement operation position places the movable support member 150 in the protrusion support position.

(6) In the structure described in (5), the accommodation operation position, the disengagement operation position, and the engagement operation position are arranged in the order named, in a direction in which the cable connector 91 is inserted into the connector 86 of the input device 80.

(7) In the structure described in any one of (1) to (6), when the engagement member 30 is in the protrusion position, the engagement sections 31 are elastically deformable in the left-right direction perpendicular to a direction in which the cable connector 91 and the device connector 86 fit together. This facilitates the operation for disengaging the engagement sections 31 of the engagement member 30 from the engagement sections 87b of the input device 80.

(8) In the structure described in (7), the operation members 40 are disposed outside the engagement sections 31 in the left-right direction. The operation members 40 include the operation sections 43 protruded from the cable connector retaining section 2, and are movable in the left-right direction according to the deformation of the engagement sections 31. According to this structure, the user can elastically deform the engagement sections 31 by operating the operation members 40. Further, the operation members 40 are movable in the front-rear direction (the connecting direction of the connectors 91 and 86) together with the engagement member 30. According to this structure, by operating the operation members 40, the user can move the engagement member 30 between the accommodation position and the protrusion position while elastically deforming the engagement sections 31.

(9) In the structure described in (8), the operation members 40 are movable in the front-rear direction together with the engagement member 30. This makes it possible to simplify the structure.

(10) In the structure described in any one of (1) to (9), the engagement member 30 includes two engagement sections 31 that are positioned on opposite sides of the cable connector 91 in the left-right direction. The engagement member 30 has the coupling section 32 that is connected to both of the two engagement sections 31. Therefore, the number of parts can be reduced to facilitate the assembly of the attachment device.

(11) In the structure described in any one of (1) to (10), the connector retaining section 2 has the outer case 10 and the inner case 20. The inner case 20 is disposed inside the outer case 10, and has the accommodation chamber A for accommodating the cable connector 91. The engagement members 30 and 130 are disposed between the inner case 20 and the inner surface of the outer case 10.

(12) In the structure described in (11), the engagement sections 31 are elastically deformable in the left-right direction when the engagement member 30 is in the protrusion position. The inner case 20 has a side surface, the engagement sections 31 are disposed along the side surface of the inner case 20, and the side surface of the inner case 20 includes the side surface 22c that is tilted with respect to the front-rear direction.

(13) The attachment device having the structure described in any one of (1) to (12) has an elastic member 51 or 170 that presses the engagement member 30 or 130 toward the accommodation position. This facilitates the operation of the attachment devices 1A and 1B.

### OTHER EXAMPLES

It should be noted that the attachment device proposed by the present disclosure is not limited to the above-described attachment devices 1A and 1B, and that various changes may be made.

For example, the attachment devices 1A and 1B are configured such that two operation members 40 are disposed outside the left and right engagement sections 31. Alternatively, however, these two operation members 40 may be integrally molded.

1. An attachment device attachable to a cable connector that is provided at an end of a cable to establish a connection between the cable and an input device, the attachment device comprising:
a connector retaining section that is attachable to and detachable from the cable connector; and
an engagement member that is provided on the connector retaining section,
wherein the engagement member includes at least one first engagement section for engaging with the input device; and
the engagement member is movable between a protrusion position and an accommodation position, the protrusion position being a position where the at least one engagement section is protruded from the connector retaining section, the accommodation position being a position where the at least one engagement section is accommodated in the connector retaining section.

2. The attachment device according to claim 1, further comprising:
an operation member,
wherein the engagement member placed in the protrusion position is movable between a position for an engaged posture and a position for a disengaged posture, the engaged posture being a posture where the engagement section engages with the input device, the disengaged posture being a posture where the engagement section does not engage with the input device, and
the operation member is movable relative to the engagement member between an engagement operation position and a disengagement operation position, the engagement operation position being a position for placing the engagement member in the engaged posture, the disengagement operation position being a position for placing the engagement member in the disengaged posture.

3. The attachment device according to claim 2,
wherein the operation member placed in the disengagement operation position presses a first section of the engagement member to place the engagement member in the disengaged posture, and the operation member placed in the engagement operation position presses a second section of the engagement member to place the engagement member in the engaged posture.

4. The attachment device according to claim 2,
wherein the engagement member is supported in such a manner that the engagement section moves in a second direction, the second direction being perpendicular to a first direction in which the cable connector and a connector of the input device fit together, and
the operation member is movable relative to the engagement member in the first direction.

5. The attachment device according to claim 2, further comprising:
a movable support member that supports the engagement member,
wherein the movable support member is movable between an accommodation support position and a protrusion support position, the accommodation support position being a position for placing the engagement member in the accommodation position, the protrusion support position being a position for placing the engagement member in the protrusion position,
the operation member is movable between an accommodation operation position, the disengagement operation position, and the engagement operation position, the operation member placed in the accommodation operation position places the movable support member in the accommodation support position, and the operation member placed in the disengagement operation position places the movable support member in the protrusion support position.

6. The attachment device according to claim 5,
wherein the accommodation operation position, the disengagement operation position, and the engagement operation position are arranged in the order named, in a direction in which the cable connector is inserted into a connector of the input device.

7. The attachment device according to claim 1,
wherein, when the engagement member is in the protrusion position, the engagement section is elastically deformable in a second direction, the second direction being perpendicular to a first direction in which the cable connector and a connector of the input device fit together.

8. The attachment device according to claim 7, further comprising:
an operation member that is positioned in the second direction with respect to the engagement section, wherein the operation member includes a section protruded from the connector retaining section, and is movable in the second direction according to deformation of the engagement section.

9. The attachment device according to claim 8,
wherein the operation member is movable in the first direction together with the engagement member.

10. The attachment device according to claim 6,
wherein the at least one engagement section includes two engagement sections that are positioned on opposite sides of the cable connector in the second direction, and
the engagement member includes a coupling section that is connected to both of the two engagement sections.

11. The attachment device according to claim 6,
wherein the connector retaining section includes an outer case and an inner case, the inner case being disposed inside the outer case and provided with an accommodation chamber for accommodating the cable connector, and
the engagement member is disposed between the inner case and an inner surface of the outer case.

12. The attachment device according to claim 11,
wherein, when the engagement member is in the protrusion position, the engagement section is elastically deformable in a second direction, the second direction being perpendicular to a first direction in which the cable connector and the connector of the input device fit together,
the inner case has a side surface,
the engagement section is disposed along the side surface of the inner case, and
the side surface of the inner case includes a slope that is tilted with respect to the first direction.

13. The attachment device according to claim 1, further comprising:
an elastic member that presses the engagement member toward the accommodation position in the first direction.
